(19) United States
(12) Patent Application Publication
(10) Pub. No.: US 2019/0368980 A1
(43) Pub. Date: Dec. 5, 2019

(54) SAMPLING DEVICE FOR HIGH TEMPERATURE CHEMICAL SOLUTIONS

(71) Applicant: ECI Technology, Inc., Totowa, NJ (US)

(72) Inventor: Sunya Barmash, Fair Lawn, NJ (US)

(73) Assignee: ECI Technology, Inc., Totowa, NJ (US)

(21) Appl. No.: 16/379,473

(22) Filed: Apr. 9, 2019

Related U.S. Application Data
(60) Provisional application No. 62/678,089, filed on May 30, 2018.

(51) Int. Cl. G01N 1/20

(52) U.S. Cl. CPC G01N 1/2035; G01N 2001/205

(57) ABSTRACT

The present disclosure relates to sampling devices for sampling solutions, such as high temperature chemical solutions, in certain industrial processes. The sampling device is integrated with a recirculation line from which a sample is drawn thereby reducing or preventing clogging of processes components resulting from precipitation of the solution.

### CROSS-REFERENCE TO RELATED APPLICATIONS

This application claims priority to U.S. Provisional Application Ser. No. 62/678,089 filed May 30, 2018, the contents of which are hereby incorporated by reference in their entirety.

### FIELD

The present disclosure relates to sampling devices for sampling solutions such as high temperature chemical solutions used in certain industrial processes, systems including the same, and methods related to sampling such solutions.

### BACKGROUND

Chemical solutions have been used for cleaning and etching surfaces in certain industrial processes, for example, in the semiconductor, electronics, solar energy, metal finishing, and printed wiring board (PWB) industries. During these processes, predetermined concentrations of such chemical solutions are maintained through measuring and monitoring. In order to analyze solution concentration, certain techniques can be used including the use of a sampling device to sample the chemical solution from a process tank of a process instrument. The chemical solution is circulated to and from the process tank through a recirculation line. The sampling device samples and receives the chemical solution from the recirculation line (e.g., via tubing) and the sample is directed toward a measuring unit located downstream. The sample is then measured and analyzed in the measuring unit and the concentration of the solution components determined. The concentration of the chemical solution components can then be adjusted, for example, by adding certain chemical reagents.

Some processes, for example, in the manufacturing of semiconductor chips or other industries require chemical solutions at high temperatures. Further, semiconductor cleaning and etching processes can have elevated operating temperatures. Certain sampling devices provide tubing between the recirculation line and the sampling device. To measure the concentrations of the components of the chemical solution in a process tank (e.g., plating, etching, or cleaning), a sample is drawn from the recirculation line located between the process tank and the sampling device. The sampling device at certain time periods opens the flow of a sample to the measuring unit (e.g., an analyzer). Thus, the time period (e.g., from minutes to hours) between sampling the high temperature chemical solution may result in a decrease in temperature of the solution inside the sampling device and downstream of the sampling device causing precipitation. Precipitation of the solution can clog components of the sampling and measuring system (e.g., tubes, valves, sensors and other devices). Further, tubing and other components between the sampling device and the measuring unit located downstream can be cleaned with a cleaning solution. However, cleaning of the channel located between the recirculation line and the sampling device can lead to contamination of the solution in the recirculation line. Contamination of the solution in recirculation line can damage the product in the process tank.

Thus, there remains a need for a sampling device for sampling solutions such as high temperature chemical solutions in certain industrial processes that reduces or prevents precipitation of the solution and clogging of components of the system. The present disclosure addresses these and other needs.

### SUMMARY

The disclosed subject matter provides novel sampling devices for sampling solutions such as high temperature chemical solutions in monitoring the concentrations thereof during process control and a monitoring system including the same.

As embodied herein, an exemplary embodiment of the present disclosure provides a sampling device. The sampling device can include a circulation channel, a sampling tee, and a sample channel. The circulation channel can include an inlet port and an outlet port. The circulation channel can be configured to receive the solution for sampling. The sampling tee can be disposed between the inlet port and the outlet port. The sampling tee can be configured to sample the solution from the circulation channel. The sample channel can be configured to receive the sampled solution from the sampling tee.

In certain embodiments, the sampling device can further include a solution control mechanism. The solution control mechanism can be disposed between the sampling tee and the sample channel. The solution control mechanism can be configured to control the amount of sampled solution received by the sample channel.

In certain embodiments, the solution control mechanism is a valve. The valve can include a fixed or adjustable opening.

In certain embodiments, the solution is a high temperature chemical solution.

In certain embodiments, the sampling solution samples a predetermined volume of the solution.

The presently disclosed subject matter further provides an apparatus for monitoring a concentration of a process solution. The apparatus can include a recirculation line, a sampling device, and a monitoring device. The sampling device can be coupled to the recirculation line. The sampling device can include a circulation channel, a sampling tee, and a sample channel. The circulation channel can include an inlet port and an outlet port. The inlet port and the outlet port can each be configured to be coupled to the recirculation line. The sampling tee can be disposed between the inlet port and the outlet port. The sampling tee can be configured to sample the solution from the circulation channel. The sample channel can be configured to receive the sampled solution from the sampling tee. The measuring device can be configured to receive the sampled solution from the sample channel. The measuring device can be configured to determine the concentration of the sampled solution.

In certain embodiments, the monitoring system further includes a cooler. The cooler can be disposed between the sampling device and the monitoring device.

In certain embodiments, the sampling device can further include a solution control mechanism. The solution control mechanism can be disposed between the sampling tee and the sample channel.

Further features and advantages of the presently disclosed subject matter will be apparent to those skilled in the art from the following detailed description, taken together with the accompanying drawings.

### BRIEF DESCRIPTION OF THE DRAWINGS

FIG. 1A illustrates a sampling device including a solution control device in a closed position in accordance with certain non-limiting embodiments.

FIG. 1B illustrates a sampling device including a solution control device in an open position in accordance with certain non-limiting embodiments.

FIG. 2 illustrates a monitoring system including a sampling device in accordance with certain non-limiting embodiments.

FIG. 3 illustrates a monitoring system including a sampling device in accordance with certain non-limiting embodiments.

### DETAILED DESCRIPTION

The presently disclosed subject matter provides novel sampling devices for sampling solutions such as high temperature chemical solutions used in certain industrial processes, systems including the same, and methods related to sampling such solutions. The presently disclosed subject matter provides sampling devices having an integrated anti-clogging feature which reduces or prevents precipitation of solutions (e.g., high temperature chemical solutions) during sampling for process control.

The terms used in this specification generally have their ordinary meanings in the art, within the context of this disclosure and in the specific context where each term is used. Technical terms used in this disclosure are used in a manner as generally known to those skilled in the art. Certain terms are discussed below, or elsewhere in the specification, to provide additional guidance in describing the devices, systems and methods of the present disclosure.

References to “embodiment,” “an embodiment,” “one embodiment”, “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the disclosure, it will be apparent to one skilled in the relevant art(s) how to implement the disclosure in alternative embodiments.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

The phrase “predetermined concentration” refers to a known, target, or optimum concentration of a component in solution.

The phrase “chemical solution” refers to a homogenous mixture of two or more substances, for example, a solute dissolved in a solvent. The phrase “chemical solution” can refer to etching or cleaning solutions used in etching or cleaning processes.

The phrase “high temperature chemical solution” refers to a chemical solution having a temperature of at least about 120° C.

The phrase “precipitation temperature” refers to a temperature at which a component in a chemical solution precipitates from the solution forming a separable solid substance from the solution.

The terms “coupled” or “couples” refers to one or more components being combined with each other and as used herein is intended to mean either an indirect or a direct connection. Thus, if one device couples to a second device, that connection may be through a direct connection, or through an indirect mechanical or other connection via other devices or connections.

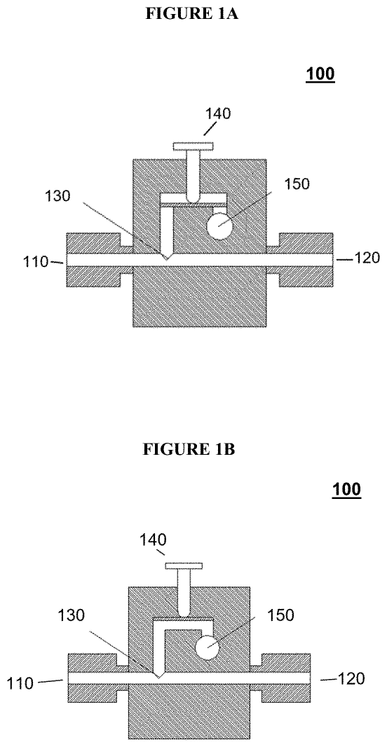

FIGS. 1A and 1B provide non-limiting exemplary diagrams of a sampling device of the presently disclosed subject matter including a solution control device in a closed and open position, respectively. In certain embodiments, the sampling device can be used to sample a predetermined volume of sample of a solution, for example, a high temperature chemical solution. The high temperature chemical solution can include, for example, hot phosphoric acid having a temperature of from about 120° C. to about 200° C. A person of skill in the art will appreciate that a wide variety of solutions are suitable for use with the present disclosure. In certain embodiments, the solution can have a temperature of from about 120° C. to about 200° C., about 120° C. to about 180° C., about 120° C. to about 160° C., about 120° C. to about 140° C., about 140° C. to about 200° C., about 140° C. to about 180° C., about 140° C. to about 160° C., about 160° C. to about 200° C., about 160° C. to about 180° C., or about 180° C. to about 200° C. In alternative embodiments, the solution can have a temperature less than about 120° C. In particular embodiments, the solution can have a temperature of at least about 120° C., about 140° C., about 160° C., or about 180° C. Preferably, in certain embodiments, the solution can have a temperature of from about 160° C. to about 180° C.

In certain embodiments, the sampling device 100 can include an inlet port 110, an outlet port 120, a sampling tee 130, a solution control device 140, and a channel 150. In certain embodiments, the inlet port 110 can supply the sampling device 100 with a solution from a process tank of a process instrument. In certain embodiments, the outlet port 120 can supply the solution to the process tank of the process instrument. Thus, the solution can be recirculated through the sampling device 100 from the process tank of the process instrument. A channel between the inlet port 110 and outlet port 120 can be disposed inside the body of the sampling device 100. Heat from the solution in a recirculation line connected to the inlet port 110 and outlet port 120 can maintain the temperature of the solution in the sampling device 100 above a precipitation temperature of the solution. The precipitation temperature of the solution can include for certain etching solutions a hot phosphoric acid having a temperature of about 120° C. Further, heat can be transmitted to the body of the sampling device 100 through the channel between the inlet port 110 and outlet port 120 and reduce or prevent cooling of the solution inside the sampling device 100 between periods of sampling.

In certain embodiments, the sampling device 100 can further include the sampling tee 130. The sampling tee 130 can be disposed between the inlet port 110 and the outlet port 120. The sampling tee 130 can be configured to collect a sample of the solution of a predetermined volume, for example, from about 15 mL to about 50 mL. For example, the sampling tee 130 can collect about 15 mL to about 45 mL, about 15 mL to about 40 mL, about 15 mL to about 35 mL, about 15 mL to about 30 mL, about 15 mL to about 25 mL, or about 15 mL to about 20 mL of solution. For example, the sampling tee 130 can collect about 15 mL, about 20 mL, about 25 mL,about 30 mL, about 35 mL, about 40 mL, about 45 mL, or about 50 mL of solution. Preferably, in certain embodiments, the sampling tee 130 can collect about 15 mL to about 30 mL of solution. Thus, the sampling tee 130 can collect a sample of the solution circulated through the sampling device 100 from the inlet port 110 to the outlet port 120. Accordingly, the sample is not provided to the sampling device 100 through tubing connected to a recirculation line. In certain embodiments, the sampling device 100 can further include the solution control device 140. The solution control device 140 can be disposed between the sampling tee 130 and the outlet port 120. In certain embodiments, the solution control device 140 can control delivery of the solution to a measuring device located downstream.

Referring to FIG. 1A, in a closed state, the solution control device 140 can at least partially block the sample or solution, for example, from being supplied to the measuring device located downstream. Referring to FIG. 1B, in an open state, the solution control device 140 can allow for at least partial delivery of the sample or solution to the measuring device located downstream. The solution control device 140 can include a valve. The solution control device 140 can include, for example, a diaphragm valve. The diaphragm valve can include a pneumatic or solenoid actuator. The diaphragm valve can include a diaphragm having a fixed opening having two positions. The two positions of the diaphragm can include a closed position (i.e., blocking at least a portion to all solution flow) and an opened position (i.e., providing a maximum orifice for solution flow) for controlling solution flow through the solution control device 140. The solution control device 140 can include, for example, an adjustable valve. The adjustable valve can include a diaphragm travel restrictor (e.g., an adjustable mechanical stop). The diaphragm travel restrictor can regulate a size of an orifice (i.e., a flow rate of the solution) of the solution control device 140 in open position. A person of skill in the art will appreciate that a wide variety of valves and mechanisms are suitable for use with solution control devices 140 of the present disclosure. In certain embodiments, the sampling device 100 can further include the channel 150. The channel 150 can provide the sample to the measuring device located downstream. In certain embodiments, the channel 150 can be located inside a manifold with several sampling devices if a plurality of recirculation lines are provided. The channel 150 can be connected to a cooler located downstream, for example, with tubing. The channel 150 can also be connected to analytical cells to measure the concentration of the components of the solution. In certain embodiments, the solution control device 140 can be disposed between the sampling tee 130 and the channel 150. Thus, the solution control device 140 can control the delivery of the sample or solution from the sample tee 130 through the channel 150 to the measuring device.

The presently disclosed subject matter can include a monitoring system. For example and without limitation, such a monitoring system can include one or more sampling devices as disclosed above and be included in a processing system.

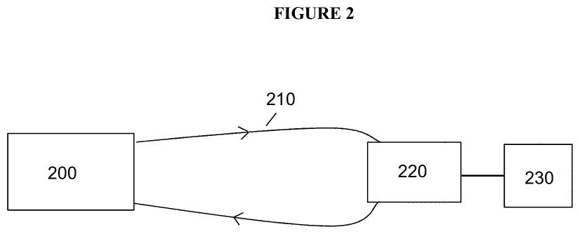

FIG. 2 provides a non-limiting exemplary diagram of a monitoring system including a sampling device and a processing system including the same. In certain embodiments, the processing system can include a process instrument 200. In certain embodiments, the monitoring system can include a recirculation line 210, a sampling device 220, and a measuring device 230. In certain embodiments, the process instrument 200 can be used to perform a certain procedural step in a manufacturing process. In certain embodiments, the processing system can include one or more process instruments 200. The process instrument 200 can include a process tank. The process tank can contain a solution, for example, a high temperature chemical solution for use in the process. The solution can be recirculated to the process tank of the process instrument 200 through the recirculation line 210. The recirculation line 210 can have a relatively high temperature. For example, in certain embodiments, the recirculation line 210 can have a temperature of at least about 120° C., about 140° C., about 160° C., about 180° C., or about 200° C. In particular embodiments, the recirculation line 210 can have a temperature of about 120° C. to about 200° C., 140° C. to about 180° C., or about 160° C. to about 180° C.

In certain embodiments, the recirculation line 210 can be integrated with the sampling device 220. For example, the recirculation line 210 can be continuous with the inlet port and the outlet port of the sampling device 220. The sampling device 220 can be used to sample a predetermined volume of sample of a solution from the process tank of the process instrument 200. In certain embodiments, the sampling device 220 can be connected to a measuring device 230 located downstream. The measuring device 230 can measure the concentration of the solution sampled from the recirculation line 210 by the sampling device 220. The measuring device 230 can include a spectroscopic cell with light source and spectrometer, an analytical cell with, for example, an ion selective electrode, a pH electrode, a conductivity electrode, or combinations thereof. A person of skill in the art will appreciate that a wide variety of measuring devices are suitable for use with the present disclosure.

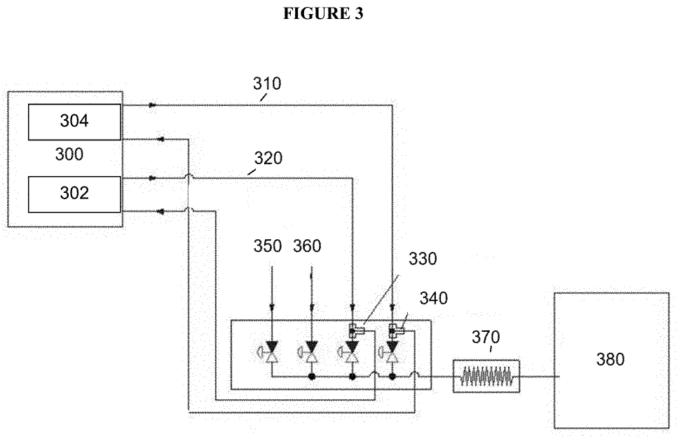

FIG. 3 provides a non-limiting exemplary diagram of a monitoring system including a sampling device including one or more sampling tees and a processing system including the same. The processing system can include a process instrument 300 including first and second process tanks 302 and 304. The monitoring system can include first and second recirculation lines 310 and 320, a sampling device including first and second sampling tees 330 and 340, first and second valves 350 and 360, a cooler 370, and a measuring device 380. The process system can include the process instrument 300. The process instrument 300 can perform a certain production step in a manufacturing process. In certain embodiments, the processing system includes one or more process instruments 300. In certain embodiments, the process instrument 300 can include one or more process tanks 302 and 304. The process tanks 302 and 304 can contain solutions, for example, high temperature chemical solutions for use during the production step. In certain embodiments, the process instrument 300 can include first and second process tanks 302 and 304. The first and second process tanks 302 and 304 can include a same solution. In certain embodiments, the first and second process tanks 302 and 304 can include different solutions. The monitoring system can include first and second recirculation lines 310 and 320. In certain embodiments, the second recirculation line 320 can be connected to the first process tank 302 of the process instrument 300. In certain embodiments, the first recirculation line 310 can be connected to the second process tank 304 of the process instrument 300. The first and second recirculation lines 310 and 320 can recirculate the solution to and from the second and first tanks 302 and 304 of the process instrument 300, respectively. The first and second recirculation lines 310 and 320 may each have a relatively high temperature. For example, in certain embodiments, the first and second recirculation lines 310 and 320 can have a temperature of at least about 120° C., about 140° C., about 160° C., about 180° C., or about 200° C. In particular embodiments, the first and second recirculation lines 310 and 320 can have a temperature of about 120° C. to about 200° C., 140° C. to about 180° C., or about 160° C. to about 180° C.

In certain embodiments, the monitoring system can further include the sampling device including first and second sampling tees 330 and 340, respectively. The first sampling tee 330 can be connected to the second recirculation line 320. For example, the first sampling tee 330 can be integrated with the second recirculation line 320. The first sampling tee 330 can take a sample of the solution circulating through the second recirculation line 320 to the first process tank 302. The second sampling tee 340 can be connected to the first recirculation line 310. For example, the second sampling tee 340 can be integrated with the first recirculation line 310. The second sampling tee 340 can take a sample of the solution circulating through the first recirculation line 310 to the second process tank 304. In certain embodiments, the monitoring system can further include first and second valves 350 and 360. The first and second valves 350 and 360 can be used to introduce additional elements into the system, for example, nitrogen or a cleaning solution. For example and without limitation, nitrogen can be introduced into the system through the first valve 350, and a cleaning solution can be introduced into the system through the second valve 360. A person of skill in the art will appreciate that a wide variety of mechanisms are suitable for use as first and second valves 350 and 360 of the present disclosure. In certain embodiments, the monitoring system can further include the cooler 370. The cooler 370 can reduce the temperature of the sample prior to analysis in the measuring device 380. In certain embodiments, the cooler 370 can include outer tubing and sampling tubing. The outer tubing can include stainless steel. The sampling tubing can be disposed within the outer tubing. Cooling water can flow between an inner surface of the outer tubing and an outer surface of the sampling tubing. The flow of the cooling water can be adjusted to have predetermined temperature of the sample after the cooler 370, for example, at a temperature of from about 20° C. to about 40° C., about 25° C. to about 35° C., or about 30° C. In particular embodiments, the sample can be adjusted to a temperature of at least about 20° C., 25° C., 30° C., 35° C., or 40° C. after the cooler 370. A person of skill in the art will appreciate that various cooler configurations are suitable for use with the present disclosure. The measuring device 380 can be located downstream of the cooler 370. The measuring device 380 can measure, for example, a concentration of the solution components. A person of skill in the art will appreciate that a wide variety of measuring devices are suitable for use with the present disclosure.

Thus, the present disclosure provides sampling devices having an integrated anti-clogging feature which reduces or prevents precipitation of solutions such as high temperature chemical solutions during sampling for process control. In certain embodiments, the sampling device can be integrated with a recirculation line. Thus, the sampling device can have an inlet port and an outlet port configured to be connected to the recirculation line. The relatively high temperature of the recirculation line can be a heat source and increase the temperature of the sampling device. Accordingly, the temperature of the high temperature chemical solution will not lower prior to sampling and precipitation thereof can be reduced or prevented to provide an integrated anti-clogging feature.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purpose of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A sampling device for sampling a solution, comprising:
a circulation channel comprising an inlet port and an outlet port, wherein the circulation channel is configured to receive the solution for sampling,
a sampling tee disposed between the inlet port and the outlet port and configured to sample the solution from the circulation channel, and
a sample channel configured to receive the sampled solution from the sampling tee.

2. The sampling device of claim 1, wherein the sampling device further comprises a solution control mechanism disposed between the sampling tee and the sample channel, and the solution control mechanism is configured to control the amount of the sampled solution received by the sample channel.

3. The sampling device of claim 2, wherein the solution control mechanism comprises a valve, the valve comprising a fixed or adjustable opening.

4. The sampling device of claim 1, wherein the solution is a high temperature chemical solution.

5. The sampling device of claim 1, wherein the sampling solution samples a predetermined volume of the solution.

6. An apparatus for monitoring the concentration of a process solution, comprising:
a recirculation line;
a sampling device coupled to the recirculation line, the sampling device comprising:
a circulation channel comprising an inlet port and an outlet port each configured to be coupled to the recirculation line; and
a sampling tee disposed between the inlet port and the outlet port and configured to sample the solution from the circulation channel;
a sample channel configured to receive the sampled solution from the sampling tee; and
a measuring device configured to receive the sampled solution from the sample channel and determine the concentration of the sampled solution.

7. The apparatus of claim 6 further comprising a cooler disposed between the sampling device and the measuring device.

8. The apparatus of claim 6, wherein the sampling device further comprises a solution control mechanism disposed between the sampling tee and the sample channel.
